(19) United States
(12) Patent Application Publication
(10) Pub. No.: US 2024/0316563 A1
(43) Pub. Date: Sep. 26, 2024

(54) LIMITED WELL THERMAL CYCLING DEVICE

(71) Applicant: MATERIALS AND MACHINES CORPORATION OF AMERICA, Lincoln, NE (US)

(72) Inventors: Abraham Oommen, Lincoln, NE (US); Jay Zarekar, Framingham, MA (US); Trevor Craig, Lincoln, NE (US); Matthew Greenleaf, Lincoln, NE (US); Michael Carrie, Meyreuil (FR); Govardhan Rathniah, Lincoln, NE (US)

(73) Assignee: MATERIALS AND MACHINES CORPORATION OF AMERICA, Lincoln, NE (US)

(21) Appl. No.: 18/269,369

(22) PCT Filed: Dec. 19, 2021
(86) PCT No.: PCT/US21/64256

§ 371 Date: Jun. 23, 2023

Related U.S. Application Data
(60) Provisional application No. 63/130,073, filed on Dec. 23, 2020.

(51) Int. Cl. B01L 7/00

(52) U.S. Cl. CPC B01L 7/52; B01L 2200/025; B01L 2200/10; B01L 2300/0654; B01L 2300/12; B01L 2300/1822; B01L 2300/1827; B01L 2300/1894

(57) ABSTRACT

A limited well thermal cycling device for sample preparation and real-time fluorescence detection is described. The limited well thermal cycling device includes a heating block having a sample well and at least one reaction well and an optical block including a corresponding means for measuring real time fluorescence in each reaction well. The limited well thermal cycling device includes a means for efficient heating and cooling of reaction and sample wells for real-time fluorescence detection. The structure of the heating block provides the means for efficient heating and cooling by having each of the sample well and at least one reaction wells rising above the heating block base, such that the sample well and at least one reaction well are not surrounded by the metal heating block.

### REFERENCE TO RELATED APPLICATION

This application is a national stage entry under 35 U.S.C. § 371(f) of PCT/US21/64256 entitled “LIMITED WELL THERMAL CYCLING DEVICE” filed Dec. 19, 2021, which claims priority to provisional application U.S. 63/130,073, filed on Dec. 23, 2020, entitled “LIMITED WELL THERMAL CYCLING DEVICE, which is incorporated herein by reference in its entirety.

### BACKGROUND

Thermal cycling devices are laboratory apparatuses that provide amplification of nucleic acid segments (DNA, RNA) through polymerase chain reaction (PCR) by providing cyclical heating and cooling according to a PCR protocol. Such thermal cyclers are used in research settings and hospital settings for different applications ranging from mutation detection in human genes to pathogen detection. These thermal cycling devices may be real-time (where fluorescence is detected from the reaction in real-time) or amplification devices only that amplify nucleic acids using a PCR cycling protocol or by isothermal amplification. In the case of plain thermal cyclers without simultaneous detection (non, real-time machines) the amplified product is detected by another means, for example by loading a gel and staining with an intercalating dye after electrophoresis to detect the amplified product.

Many conventional thermal cycling devices exist, such as U.S. Pat. Nos. 5,333,675, 5,475,610 and 5,656,493 which are directed toward nucleic acid amplification in a single tube, as well as amplification in 96 well plates. Further, another conventional thermal cycling device includes nucleic acid amplification by separation of each sample tube for individual heating and cooling control using microfluidics, as described in U.S. Pat. No. 6,521,447, which notably does not use a thermal cycler block for cyclical heating and cooling. Moreover, conventional devices include rapid PCR via thermal cycling in a block using single or multiple thin walled glass capillaries are taught in U.S. Pat. No. 7,238,321. Each of the conventional devices is directed toward amplification and detection of nucleic acids using single samples (and therefore the device has a single reaction well) or multiple samples simultaneously (and therefore the device has multiple reaction wells such as a 96 well plate). These conventional devices address efficiency factors of the thermal cycling, and in particular, speed and temperature control.

These conventional devices, such as the device of U.S. Pat. No. 7,238,321, teach converting thermal cyclers to also detect amplification in real-time using fluorescent detection through, fluorescent dyes, including intercalating dyes. For example, the conventional devices in U.S. Pat. Nos. 6,171,785 and 6,814,934 detect fluorescence from one reaction vessel or multiple reaction vessels, where the amplification and detection occurs in the same reaction well. These conventional devices all share a primary features of a thermal block including a metallic block with machined holes that serve as reaction wells that allow typical reaction tubes (reaction vessels) seen in a standard laboratory to be used to process the amplification and detection reactions.

These standard reaction tubes or vessels can be single reaction tubes (ranging from small capillaries to 0.2 ml PCR tubes with caps) or multiple well tubes (such as tubes for use in 8 well or 0.2 ml strips) to 96 well, 384 well or 1536 well micro-tier dish type plates. All such reaction formats are accepted in these conventional thermal cycling devices noted here, and many conventional devices are designed to accept one or two of the most abundantly available reaction vessels. It follows that the reaction wells of these thermal cycling devices must be shaped to hold the reaction vessel in a tight fit so that heat transfer is efficient, as the heating and cooling of the thermal block controls the heating and cooling of the sample in the reaction vessel.

To accommodate these standard reaction tubes, the conventional devices include reaction wells having the bottom part of the reaction well tapered to provide a snug fit with the corresponding tapered reaction tube. As used herein “tapered” means that the bottom of the reaction tube and/or the bottom of the reaction wells are either “V” shaped or “U” shaped, with the “V” shape being most common. These conventional devices lack the ability to accommodate non-standard reaction tubes, such as flat bottomed reaction tubes.

Additionally, other conventional devices provide sample preparation, followed by nucleic acid amplification and detection within the same device. For example, U.S. Pat. No. 5,863,502 accomplishes this amplification and detection in parallel through fluid movement, whereas Application WO 2007106579A2 provides amplification and detection in a fully integrated manner through microfluidics (WO2007106579A2). Both of these devices require significant fluid movement and control between chambers and reaction tubes. Thermal cycling is achieved in such devices through simple heating and cooling systems. Similarly, these conventional devices also incorporate unique ways of detecting fluorescence by incorporating appropriate optics like image capturing as seen in Application WO2007106579A2 or wave guides as seen in U.S. Pat. No. 5,832,165. These conventional devices have the drawback of requiring separate sample preparation chambers and separate chambers for amplification and therefore, significant fluid movement and control of such movement between chambers, reaction tubes, and reaction wells are needed.

Therefore it is desirable to have a thermal cycling devices that provide efficient heating and cooling with reduced material of the thermal block. It is further desirable to have a thermal cycling device that provides sample preparation, amplification, and real-time detection in the same device without significant fluid transfer or control required. Finally, it is desirable to have a thermal cycling device that provides for non-standard reaction tubes.

### FIGURES

FIG. 1 represents a limited well thermal cycling device having two reaction wells.

FIG. 2a represents a heating block of a limited well thermal cycling device having two reaction wells.

FIG. 2b represents a front view of a heating block of a limited well thermal cycling device having two reaction wells.

FIG. 3a represents an optical block of a limited well thermal cycling device having two reaction wells.

FIG. 3b represents a front view of a limited well thermal cycling device having two reaction wells.

FIG. 3c represents a side view of a limited well thermal cycling device having two reaction wells.

FIG. 4 represents a heating block and an optical block of a limited well thermal cycling device having two reaction wells.

FIG. 5 represents a limited well thermal cycling device having two reaction wells.

FIG. 6 represents a heating block of a limited well thermal cycling device having one reaction well.

FIG. 7 represents a limited well thermal cycling device (heating block with optical block) having one reaction well.

### SUMMARY

In aspects, a limited well thermal cycling device for preparation of a biological sample for amplification and detection of an analyte, the limited well thermal cycling device includes a heating block configured for preparation of the biological sample and amplification of the analyte, the heating block comprising a sample well having a flat bottom configured for receiving and preparing the biological sample for amplification and detection, the sample well extending from a top of a heating block base; a reaction well having a flat bottom configured for receiving and amplifying an analyte of the prepared biological sample for detection, the reaction well extending from the top of the heating block base, wherein the reaction well has an excitation orifice, an emission orifice, and a cooling orifice, where the excitation orifice and emission orifice are in 90 degree alignment; and heating block alignment holes for removable attachment of an optical block to the heating block base, the heating block alignment holes on the top of the heating block base; the optical block configured for detecting the analyte of the amplified and prepared biological sample, wherein the optical block is in removable attachment with the heating block, the optical block comprising an inner excitation orifice and an outer excitation orifice, the inner excitation orifice having a smaller diameter than the outer excitation orifice where the inner and outer excitation orifice are in continuing alignment through a central portion of the optical block, wherein a center of the inner and outer excitation orifice is in linear alignment with a center of the reaction well excitation orifice; an LED board having an LED, the LED board in removable attachment with the optical block where the LED is received by the outer excitation orifice; a photodiode board having a photodiode, the photodiode board in removable attachment with the optical block where the photodiode is received by the outer emission orifice; an excitation filter, the excitation filter received by a ledge of the outer excitation orifice, the ledge formed by the continuing alignment between the inner and outer excitation orifice; an emission filter, the emission filter received by a ledge of the outer emission orifice, the ledge formed by the continuing alignment between the inner and outer emission orifice; and a heating element in heating communication with the heating block to provide heat transfer to the sample well and reaction well.

In aspect, a limited well thermal cycling device for preparation of a biological sample for amplification and detection of an analyte, the limited well thermal cycling device including a heating block configured for preparation of the biological sample and amplification of the analyte, the heating block comprising a sample well having a flat bottom configured for receiving and preparing the biological sample for amplification and detection, the sample well extending from a top of a heating block base; a first reaction well having a flat bottom configured for receiving and amplifying a first analyte of the prepared biological sample for detection, the first reaction well extending from the top of the heating block base, wherein the first reaction well has a first excitation orifice, a first emission orifice, and a first cooling orifice, where the first excitation orifice and first emission orifice are in 90 degree alignment; and heating block alignment holes for removable attachment of an optical block to the heating block base, the heating block alignment holes on the top of the heating block base; a second reaction well having a flat bottom configured for receiving and amplifying a second analyte of the prepared biological sample for detection, the second reaction well extending from the top of the heating block base, wherein the second reaction well has a second excitation orifice, a second emission orifice, and a second cooling orifice, where the second excitation orifice and second emission orifice are in 90 degree alignment; and heating block alignment holes for removable attachment of the optical block to the heating block base, the heating block alignment holes on the top of the heating block base; the optical block configured for detecting the first and second analytes of the amplified and prepared biological sample, wherein the optical block is in removable attachment with the heating block, the optical block comprising a first inner excitation orifice and a first outer excitation orifice, the first inner excitation orifice having a smaller diameter than the first outer excitation orifice where the first inner and outer excitation orifice are in continuing alignment through a central portion of the optical block, wherein a center of the first inner and outer excitation orifice is in linear alignment with a center of the first reaction well excitation orifice; a second inner excitation orifice and a second outer excitation orifice, the second inner excitation orifice having a smaller diameter than the second outer excitation orifice where the second inner and outer excitation orifice are in continuing alignment through the central portion of the optical block, wherein a center of the second inner and outer excitation orifice is in linear alignment with a center of the second reaction well excitation orifice; an LED board having a first and a second LED, the LED board in removable attachment with the optical block where the first LED is received by the first outer excitation orifice and the second LED is received by the second outer excitation orifice; a photodiode board having a first and a second photodiode, the photodiode board in removable attachment with the optical block where the first photodiode is received by the first outer emission orifice and the second photodiode is received by the second outer emission orifice; a first excitation filter, the first excitation filter received by a ledge of the first outer excitation orifice, the ledge formed by the continuing alignment between the first inner and first outer excitation orifice; a second excitation filter, the second excitation filter received by a ledge of the second outer excitation orifice, the ledge formed by the continuing alignment between the second inner and second outer excitation orifice; a first emission filter, the first emission filter received by a ledge of the first outer emission orifice, the ledge formed by the continuing alignment between the first inner and first outer emission orifice; a second emission filter, the second emission filter received by a ledge of the second outer emission orifice, the ledge formed by the continuing alignment between the second inner and second outer emission orifice; and a heating element in heating communication with the heating block to provide heat transfer to the sample well and first and second reaction wells.

In aspects, a limited well thermal cycling device for preparation of a biological sample for amplification and detection of an analyte, the limited well thermal cycling device includes a heating block configured for preparation of the biological sample and amplification of the analyte, the heating block comprising a sample well having a means for receiving a sample tube having a flat bottom, the sample well extending from a top of a heating block base; a reaction well configured for amplifying an analyte of the prepared biological sample for detection, the reaction well extending from the top of the heating block base, wherein the reaction well has an excitation orifice, an emission orifice, and a cooling orifice, where the excitation orifice and emission orifice are in 90 degree alignment; and heating block alignment holes for removable attachment of an optical block to the heating block base, the heating block alignment holes on the top of the heating block base; the optical block having a means for measuring the real time fluorescence of the analyte of the sample; and a heating element in heating communication with the heating block to provide heat transfer to the sample well and reaction well.

In aspects, a limited well thermal cycling device for preparation of a biological sample for amplification and detection of an analyte, the limited well thermal cycling device includes a heating block configured for preparation of the biological sample and amplification of the analyte, the heating block comprising a sample well having a tapered bottom configured for receiving and preparing the biological sample for amplification and detection, the sample well extending from a top of a heating block base; a reaction well having a tapered bottom configured for receiving and amplifying an analyte of the prepared biological sample for detection, the reaction well extending from the top of the heating block base, wherein the reaction well has an excitation orifice, an emission orifice, and a cooling orifice, where the excitation orifice and emission orifice are in 90 degree alignment; and heating block alignment holes for removable attachment of an optical block to the heating block base, the heating block alignment holes on the top of the heating block base; the optical block configured for detecting the analyte of the amplified and prepared biological sample, wherein the optical block is in removable attachment with the heating block, the optical block comprising an inner excitation orifice and an outer excitation orifice, the inner excitation orifice having a smaller diameter than the outer excitation orifice where the inner and outer excitation orifice are in continuing alignment through a central portion of the optical block, wherein a center of the inner and outer excitation orifice is in linear alignment with a center of the reaction well excitation orifice; an LED board having an LED, the LED board in removable attachment with the optical block where the LED is received by the outer excitation orifice; a photodiode board having a photodiode, the photodiode board in removable attachment with the optical block where the photodiode is received by the outer emission orifice; an excitation filter, the excitation filter received by a ledge of the outer excitation orifice, the ledge formed by the continuing alignment between the inner and outer excitation orifice; an emission filter, the emission filter received by a ledge of the outer emission orifice, the ledge formed by the continuing alignment between the inner and outer emission orifice; and a heating element in heating communication with the heating block to provide heat transfer to the sample well and reaction well.

### DETAILED DESCRIPTION

As used herein “limited well” means a thermal cycling device having from one to four reaction wells.

As used herein “sample” means a nucleic acid sample that may contain one or more sequences of interest (analytes), contains one or more nucleic acid primers to detect the nucleic acid sequence of interest, and contains the PCR components for conducting the PCR reaction. Each nucleic acid primer could be labeled with a fluorophore, each fluorophore having unique absorption and emission properties for detection by fluorescence emission. For example, detection of the analyte by fluorescence emission via fluorophores may occur through primer extension of a probe as a result of using labeled nucleotides, through molecular beacon or similar fluorophore, and through quencher based primers or other means to detect fluorescence.

A limited well thermal cycling device for sample preparation and real-time fluorescence detection is described. The limited well thermal cycling device includes a heating block having a sample well and at least one reaction well and an optical block including a corresponding means for measuring real time fluorescence in each reaction well.

The limited well thermal cycling device includes a means for efficient heating and cooling of reaction and sample wells for real-time fluorescence detection. The structure of the heating block provides the means for efficient heating and cooling by having each of the sample well and at least one reaction well rising above the heating block base, such that the sample well and at least one reaction well are not surrounded by the metal heating block.

The reaction and sample wells of the limited well thermal cycling device may include a means for receiving flat bottom sample and reaction vessels allowing for this flat-bottomed vessel design to be used in connection with real-time fluorescence detection. The structure of the sample and at least one reaction well provides the means for receiving flat bottom sample and reaction vessels as each of the sample and at least one reaction wells have a flat bottom for receiving the sample and reaction vessels. This flat bottom design allows for efficient heating of the sample by providing more surface area of the bottom of the sample tube to be in contact with reaction well closest to the heating block. The reaction and sample wells of the limited well thermal cycling device may be of tapered shape to receive standard reaction tubes.

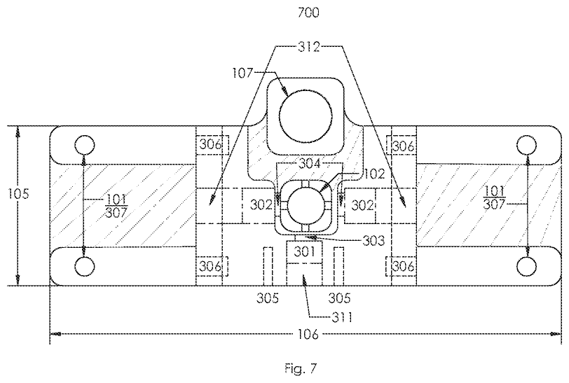

FIG. 7 represents a limited well thermal cycling device 700 having one reaction well. The limited well thermal cycling device 700 includes a heating block 100 and an optical block 300. The heating block 100 is shown with diagonal shading to differentiate it from the optical block 300 that resides on top of the heating block 100. The heating block 100 includes a sample well 107 and a reaction well 102.

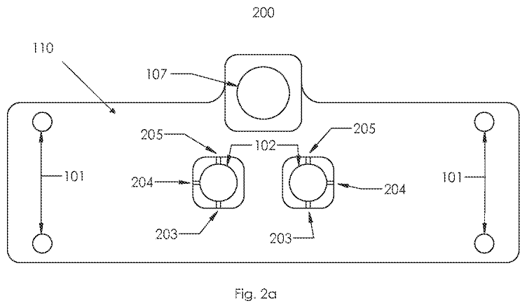

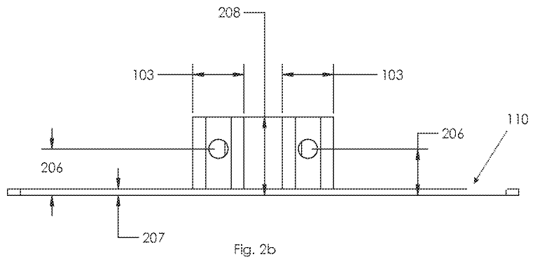

The heating block 100 has a base 110 having a height (thickness) 207 from 0.5 mm to 3 mm (see FIG. 2b). Preferably the base height 207 of the heating block 100 is 1 mm. The heating block has a width 105 from 20 mm to 30 mm, and preferably the width 105 of the heating block 100 is 25 mm. The heating block has a length 106 from 60 mm to 100 mm, and preferably the length 106 is 80 mm. The heating block 100 further includes heating block alignment holes 101 that provide alignment of the optical block 300 for removable attachment, such as through screws or the like. The heating block 100 may be made of any thermally conductive metal, metal alloys, or composite materials. Preferably, the heating block 100 is aluminum or anodized aluminum.

The heating of this block is accomplished by either a peltier thermal electric device, resistant heating element or any similar conventional heating element placed under the block 100. Cooling is accomplished by blowing air in and around the block and the three wells, by using conventional fans. For example, the conventional fans may be placed on the sides of the heating block 100, or in another location that facilitates cooling of the reaction well 102.

The sample well 107 of the heating block 100 may be configured for receiving a sample vessel having a flat bottom for preparation of the sample. The sample well 107 of the heating black 100 may be tapered to receive a sample vessel having a standard reaction tube shape. The sample well 107 includes a sample well perimeter length 108 from 10 mm to 14 mm, preferably 12 mm. The sample well 107 includes a sample well perimeter width 103 from 10 to 14 mm, preferably 12 mm. The sample well 107 includes a sample well height 208 from 10 mm to 14 mm, preferably 12.2 mm.

When the sample well 107 is configured to receive a sample vessel having a flat bottom, an interior of the sample well 107 is circular having a diameter from 6 mm to 12 mm, preferably 8.2 mm. The interior of the sample well additionally has a flat bottom to accommodate sample vessels having flat bottoms that are plastic, glass, or other thermally conductive materials. When the sample well 107 is tapered to receive a sample vessel having a standard reaction tube shape, an interior of the sample well 107 is tapered having a diameter from 6 mm to 12 mm at a top (closest to the opening) of the sample well 107.

The sample well 107 may be formed from the base 110 of the heating block 100 and is made from any thermally conductive material, such as metal, metal alloys, or composite materials. Preferably, the sample well 107 is aluminum or anodized aluminum.

A sample vessel is received by the sample well 107, where the sample within the sample vessel may be heated and cooled to desired temperatures for desired periods of time to prepare the sample for further analysis (i.e. amplification and detection) in the reaction well 102. For example, a lysis buffer made be added to the sample where the sample is heated for cell lysis and release of nucleic acids.

The reaction well 102 of the heating block 100 is configured for measuring real time fluorescence of the sample. Real time fluorescence is measured as the sample is heated and cooled to desired temperatures for desired periods of time for amplification of the sample. For example, the components required for amplification are added to the sample in the reaction well 102, where in the case of PCR amplification this includes fluorescent labeled DNA primers, free nucleotides (ddNTPs), and a DNA polymerase. Additionally, for example, the sample may undergo heating and cooling cycles using a polymerase chain reaction (PCR) protocol for amplification of a desired analyte with simultaneous real time fluorescence detection. The reaction well 102 includes a reaction well perimeter width 103 from 6 mm to 10 mm, preferably 8 mm. The reaction well 102 includes a reaction well perimeter length 104 from 6 mm to 10 mm, preferably 8 mm. The reaction well 102 includes a reaction well height (208) from 10 mm to 14 mm, preferably 12.2 mm.

When the reaction well 102 is configured to receive a sample vessel that is non-standard having a flat bottom, an interior of the reaction well 102 is circular having a diameter from 4 mm to 8 mm, preferably 5.82 mm. The interior of the reaction well 102 has a flat bottom to accommodate reaction vessels having flat bottoms that are thermally resistant plastic, glass, borosilicate glass, or other thermally conductive materials. When the reaction well 102 is tapered to receive a sample vessel having a standard reaction tube shape, an interior of the reaction well 102 is tapered having a diameter from 4 mm to 8 mm at a top (closest to the opening) of the sample well 107.

The reaction well 102 further includes a cooling orifice 205 that extends from the interior of the reaction well 102 to the perimeter to facilitate cooling of the sample with the fan. The cooling orifice 205 is from 0.5 mm to 2 mm in diameter, and preferably is 1 mm in diameter. The reaction well 102 may be formed from the base 110 of the heating block 100 and is made from any thermally conductive material, such as metal, metal alloys, or composite materials. Preferably, the reaction well 102 is aluminum or anodized aluminum.

The reaction well 102 includes a reaction well excitation orifice 203 and at least one reaction well emission orifice 204 that allow fluorescent excitation and emission of the sample for measurement of the real time fluorescence by the optical block 300. FIG. 7 represents a reaction well 102 having two reaction well emission orifices 204, but the reaction well 102 may have a single reaction well emission orifice 204. Each reaction well emission orifice 204 extends from the interior of the reaction well 102 to the perimeter to allow fluorescence from the sample to reach a photodiode 201. Each reaction well emission orifice 204 is in linear alignment with a respective photodiode 201 and an inner and outer emission orifice 304 and 312, respectively of the optical block. Each reaction well emission orifice 204 is in 90 degree alignment with the reaction well excitation orifice 203. Each reaction well emission orifice 204 is from 0.5 mm to 2 mm in diameter, and preferably is 1 mm in diameter.

The reaction well excitation orifices 203 extends from the interior of the reaction well 102 to the perimeter to allow light from an LED 202 to reach the sample. The reaction well excitation orifice 203 is in linear alignment with the LED 202 and an inner and outer excitation orifice 303 and 311, respectively. The reaction well excitation orifice 203 is from 0.5 mm to 2 mm in diameter, and preferably is 1 mm in diameter.

The optical block 300 of the limited well thermal cycling device 700 provides a means for measuring the real time fluorescence of the sample received by the sample well 102. The means for measuring the real time fluorescence of the sample of optical block 300 includes the inner excitation orifice 303, the outer excitation orifice 311, the excitation filter 301, at least one inner emission orifice 304, at least one outer emission orifice 312, at least one emission filter 302, an LED board 502, and at least one photodiode board 501. The optical block further includes a central portion 310 having LED mounting holes 305 and photodiode mounting holes 306. The optical block 300 further includes feet 309 having alignment holes 307.

The optical block 300 is in removable attachment with the heating block 100 via the heating block alignment holes 101 and alignment holes 307 of the feet 309, such as via screws. This alignment provides proper alignment of the at least one reaction well 102 with the means for measuring real time fluorescence, as further described herein. The optical block has a width from 20 mm to 30 mm, and preferably 25 mm. The optical block 300 has a length 60 mm to 100 mm, and preferably the length is 80 mm. The width and length of the optical block is equal to the length and width of the heating block 100.

The feet 309 of the optical block 300 extend from the central portion 310 and include the alignment holes 307 for removable attachment to the heating block 100. The feet 309 have a height that is smaller than the height of the central portion 310.

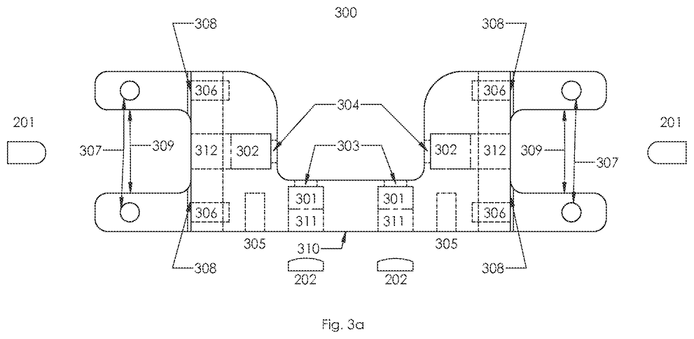

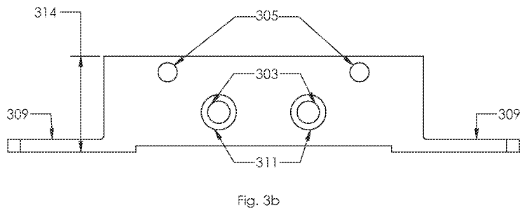

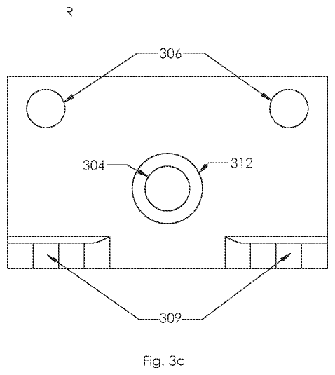

The central portion 310 has a height 314 from 12 mm to 20 mm, and preferably 16 mm. The central portion of the optical block 300 is elevated from the feet 309 at elevation points 308 (as shown in FIG. 3a). The central portion 310 of the optical block 300 includes the inner excitation orifice 303, the outer excitation orifice 311, the excitation filter 301, the at least one inner emission orifice 304, the at least one outer emission orifice 312, the at least one emission filter 302 of the means for real time fluorescence detection. The central portion further includes LED mounting holes 305 that provide removable attachment of the LED board 502, and photodiode mounting holes 306 that provide removable attachment of the at least one photodiode board 501.

The outer excitation orifice 311 extends from the perimeter of the optical block 300 to the inner excitation orifice 303. The outer excitation orifice 311 has a diameter from 4 mm to 8 mm, and preferably 5.5 mm. The outer excitation orifice 311 has a depth from 5 mm to 10 mm, and preferably 7 mm. The outer excitation orifice 311 is in linear alignment with the reaction well excitation orifice 203. The outer excitation orifice 311 houses the excitation filter 301.

The inner excitation orifice 303 extends from the outer excitation orifice 311 to an interior perimeter of the optical block 300. The inner excitation orifice 303 has a diameter from 2.5 mm to 5 mm, and preferably 3.5 mm. The depth of the inner excitation orifice 303 is from 0.5 to 4 mm, and preferably is 1 mm. The inner excitation orifice is in linear alignment with the reaction well excitation orifice 203. The diameter change from the inner to outer excitation orifices 303 and 311 creates a ledge where the excitation filter is housed by the outer excitation orifice 311 at this position closest to the inner excitation orifice 303.

The excitation filter 301 provides filtration of the light from the LED 202 to wavelengths that excite the fluorescent dye of the sample. For example, the excitation filter 301 may be an optical filter that filters light in the 475 nm to 495 nm range when the LED 202 generates wavelength in the 465 to 485 nm range. This excitation filter 301 would be sufficient for many commonly used fluorescent dyes such as fluorescein, 6-FAM (6-carboxyfluorescein) and Atto 488.

The LED board 502 is an electronic control board (e.g. includes a printed circuit board) that includes the LED 202 and the LED board attachment holes 503 and turns the LED on and off. The LED 202 excites the fluorescent dye in the sample. For example, the LED 202 may be a blue LED that generates a wavelength in the 465 to 485 nm range. The LED 202 is received by the outer excitation orifice 311. The LED board attachment holes 503 provide removable attachment of the LED board 502 to the optical block 300 at the LED mounting holes 305, such as via screws.

Each of the at least one outer emission orifice 312 extends from the perimeter of the optical block 300 to the respective inner emission orifice 304. Each of the outer emission orifices 312 has a diameter from 4 mm to 8 mm, and preferably 5.5 mm. Each of the outer emission orifices 312 has a depth from 4 mm to 8 mm, and preferably 5.5 mm. Each of the outer emission orifices 312 is in linear alignment with its respective reaction well emission orifice 204. Each of the outer emission orifices 312 houses its respective emission filter 302.

Each of the inner emission orifices 304 extends from its outer emission orifice 312 to an interior perimeter of the optical block 300. Each of the inner emission orifices 304 has a diameter from 2.5 mm to 5 mm, and preferably 3.5 mm. The depth of the inner emission orifices 304 is from 0.5 to 4 mm, and preferably is 1 mm. Each of the inner emission orifices 304 is in linear alignment with its respective reaction well emission orifice 204. The diameter change from the inner to outer emission orifices 304 and 312 creates a ledge where the emission filter 302 is housed by the outer emission orifice 312 at this position closest to the inner emission orifice 304.

Each emission filter 302 provides filtration of the fluoresced light from the sample prior to the measurement of the fluoresced light by the photodiode 201. The emission filter 302 directly corresponds to the fluorescent dye used in the sample. For example, the emission filter 302 may be an optical filter that filters light in the 517 to 537 nm range. This would be an emission filter sufficient when the fluorescent dye of the sample is 6-FAM (6-carboxyfluorescein), which has an absorbance max at 495 nm and an emission max at 520 nm. Each emission filter 302 may be the same filter or may be a different filter to provide filtration of a different wavelength of light.

Each photodiode board 502 is an electronic control board (e.g. includes a printed circuit board) that includes the photodiode 201 and photodiode board attachment holes 504. The respective photodiode 201 detects the fluoresced light emitted from the sample after it travels through the respective emission filter 302. For example, photodiodes 201 include photosensitive areas specific to detecting wavelengths from 320 to 1100 nm. Each photodiode 201 is received by its respective outer emission orifice 312. The photodiode board attachment holes 504 provide removable attachment of each photodiode board 501 to the optical block 300 at their respective photodiode mounting holes 306, such as via screws.

The inner and outer excitation orifices 303 and 311 and the inner and outer emission orifices 304 and 312 are at 90 degree angles to each other as oriented from the centers of each of the orifices. This orientation provides that the LED 202 and photodiodes 201 are at 90 degree angles to each other. FIG. 7 shows the inner and outer emission orifices 304 and 312 and the emission filter 302 at either location of 90 degrees orientation to the inner and outer excitation orifices 303 and 311.

The limited well thermal cycling device having one reaction well 102 may include two reaction well emission orifices 204 and two photodiodes 201, two inner and outer reaction well emission orifices 304 and 312, respectively, and two emission filters 302, corresponding thereto. This arrangement provides for real-time detection of two separate analytes within the same sample assuming that each reaction vessel gets the same sample. In such a situation, each photodiode 201 and emission filter 302 may be configured to detect and filter a unique fluorescence corresponding to two fluorescent dyes within the sample.

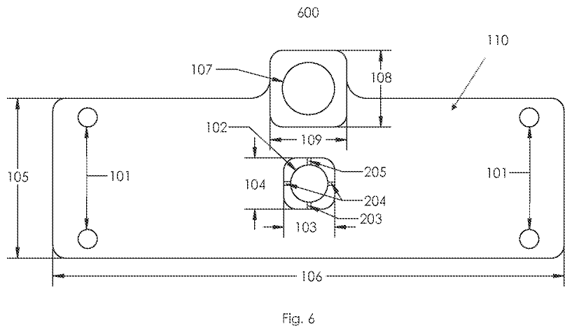

FIG. 6 represents the heating block 100 of a limited well thermal cycling device 700. This view of the heating block 100 shows the reaction well emission orifices 204, the reaction well excitation orifice 203 and cooling orifice 205.

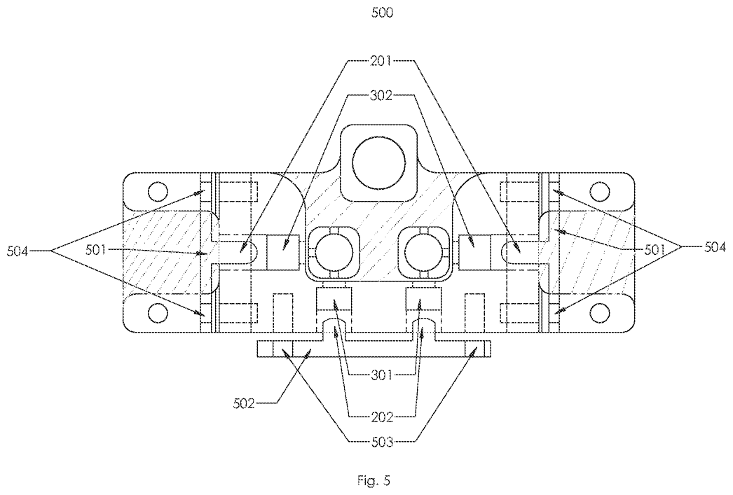

FIG. 5 represents a limited well thermal cycling device 700 having two reaction wells 102. This thermal cycling device 700 having two reaction wells 102, correspondingly has two inner and outer excitation orifices 303 and 311, two excitation filters 301, and two LEDs 202 on the LED board 502. Further, the thermal cycling device 700 has two photodiode boards 501, each having a photodiode 201, where the photodiode boards 502 are placed such that the photodiode 201 and therefore the emission orifice 204 of each is at a 90 degree angle to the excitation orifice 203 of the corresponding reaction well 102. This arrangement provides for real-time detection of two separate analytes within the same sample assuming that each reaction vessel gets the same sample. In such a situation, each photodiode 201 and emission filter 302 may be configured to detect and filter a unique fluorescence corresponding to two fluorescent dyes within the sample.

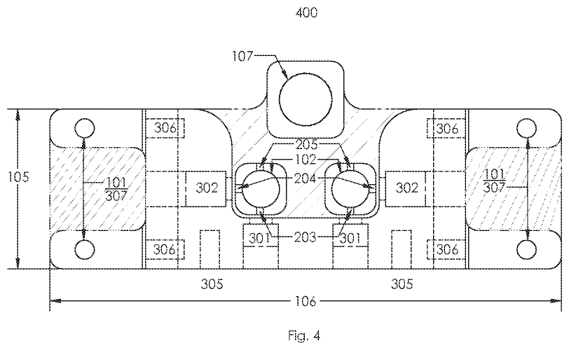

FIG. 4 represents the heating block 100 and optical block 300 of the limited well thermal cycling device 700 of FIG. 5. This view shows the reaction well emission orifices 204 and reaction well excitation orifices 203 in 90 degree alignment. Further, this view shows the reaction well cooling orifices 205.

FIG. 3a represents the optical block 300 of the limited well thermal cycling device 700 of FIG. 5, with display of the photodiodes 201 and LEDs 202 for representative positioning purposes only. This view shows the arrangement of the inner and outer excitation orifices 303 and 311 with the excitation filters 301 in place. Additionally, this view shows the inner and outer emission orifices 304 and 312 with the emission filters 302 in place.

FIG. 3b represents the front view of the optical block 300 from FIG. 3a. This view shows the inner and outer excitation orifices 303 and 311, in particular the difference in their diameters. Further, this view shows the height differentiation from the feet 309 to the central portion 310.

FIG. 3c represents the side view of the optical block 300 from FIG. 3a. This view shows the inner and outer emission orifices 304 and 312, in particular the difference in their diameters. Further, in this view the feet 309 are shaded to indicate their projection from the central portion 310.

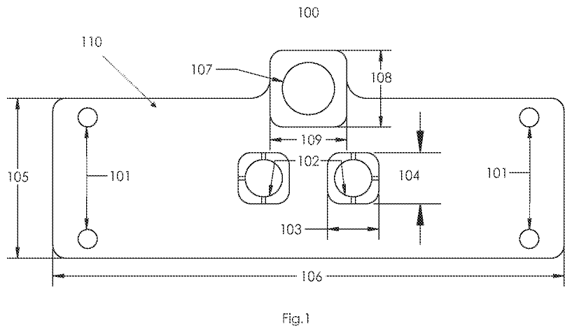

FIGS. 1 and 2a represents a top down view of the heating block 100 from FIG. 5. This view shows the reaction well emission orifices 204 and reaction well excitation orifices 203 in 90 degree alignment. Further, this view shows the reaction well cooling orifices 205.

FIG. 2b represents a front view of the heating block 100 from FIGS. 1 and 2a. This view shows the reaction wells as rising from the base 110 of the heating block 100 to illustrate that the reaction wells are not surrounded by the heating block. Additionally, this view shows a height from the heating block to the center of the reaction well excitation orifice 206, the thickness of the base 100 of the heating block 207, and the reaction well height 208.

1. A limited well thermal cycling device for preparation of a biological sample for amplification and detection of an analyte, the limited well thermal cycling device comprising:
a heating block configured for preparation of the biological sample and amplification of the analyte, the heating block comprising
a sample well having a flat bottom configured for receiving and preparing the biological sample for amplification and detection, the sample well extending from a top of a heating block base;
a reaction well having a flat bottom configured for receiving and amplifying an analyte of the prepared biological sample for detection, the reaction well extending from the top of the heating block base, wherein
the reaction well has an excitation orifice, an emission orifice, and a cooling orifice, where the excitation orifice and emission orifice are in 90 degree alignment; and
heating block alignment holes for removable attachment of an optical block to the heating block base, the heating block alignment holes on the top of the heating block base;
the optical block configured for detecting the analyte of the amplified and prepared biological sample, wherein the optical block is in removable attachment with the heating block, the optical block comprising
an inner excitation orifice and an outer excitation orifice, the inner excitation orifice having a smaller diameter than the outer excitation orifice where the inner and outer excitation orifice are in continuing alignment through a central portion of the optical block, wherein a center of the inner and outer excitation orifice is in linear alignment with a center of the reaction well excitation orifice;
an LED board having an LED, the LED board in removable attachment with the optical block where the LED is received by the outer excitation orifice;
a photodiode board having a photodiode, the photodiode board in removable attachment with the optical block where the photodiode is received by the outer emission orifice;
an excitation filter, the excitation filter received by a ledge of the outer excitation orifice, the ledge formed by the continuing alignment between the inner and outer excitation orifice;
an emission filter, the emission filter received by a ledge of the outer emission orifice, the ledge formed by the continuing alignment between the inner and outer emission orifice; and
a heating element in heating communication with the heating block to provide heat transfer to the sample well and reaction well.

2. The device of claim 1, further comprising
a reaction vessel having a flat bottom configured for being received by the reaction well, the reaction vessel made from a material that is selected from the group consisting of glass and borosilicate glass.

3. The device of claim 1, further comprising
a reaction vessel having a flat bottom configured for being received by the reaction well, the reaction vessel made from a material that is a thermally resistant plastic.

4. The device of claim 1, wherein
the outer excitation orifice has a diameter from 4 to 8 millimeters;
the inner excitation orifice has a diameter from 2.5 to 5 millimeters;
the outer emission orifice as a diameter from 4 to 8 millimeters;
the inner excitation orifice has a diameter from 2.5 to 5 millimeters.

5. The device of claim 4, wherein
the reaction well excitation orifice has a diameter from 0.5 to 2 millimeters;
the reaction well emission orifice has a diameter from 0.5 to 2 millimeters.

6. The device of claim 1, wherein
the heating block material is anodized aluminum.

7. The device of claim 6, wherein
the optical block material is delrin.

8. The device of claim 6, wherein
the optical block material is selected from the group consisting of acetal copolymers and homopolymers.

9. The device of claim 1, wherein
the sample well has a diameter from 6 to 12 millimeters; and
the reaction well has a diameter from 4 to 8 millimeters.

10. The device of claim 9, wherein
the sample well is positioned at least 5 millimeters from the reaction well.

11. A limited well thermal cycling device for preparation of a biological sample for amplification and detection of an analyte, the limited well thermal cycling device comprising:
a heating block configured for preparation of the biological sample and amplification of the analyte, the heating block comprising
a sample well having a flat bottom configured for receiving and preparing the biological sample for amplification and detection, the sample well extending from a top of a heating block base;
a first reaction well having a flat bottom configured for receiving and amplifying a first analyte of the prepared biological sample for detection, the first reaction well extending from the top of the heating block base, wherein
the first reaction well has a first excitation orifice, a first emission orifice, and a first cooling orifice, where the first excitation orifice and first emission orifice are in 90 degree alignment; and
heating block alignment holes for removable attachment of an optical block to the heating block base, the heating block alignment holes on the top of the heating block base;
a second reaction well having a flat bottom configured for receiving and amplifying a second analyte of the prepared biological sample for detection, the second reaction well extending from the top of the heating block base, wherein
the second reaction well has a second excitation orifice, a second emission orifice, and a second cooling orifice, where the second excitation orifice and second emission orifice are in 90 degree alignment; and
heating block alignment holes for removable attachment of the optical block to the heating block base, the heating block alignment holes on the top of the heating block base;
the optical block configured for detecting the first and second analytes of the amplified and prepared biological sample, wherein the optical block is in removable attachment with the heating block, the optical block comprising
a first inner excitation orifice and a first outer excitation orifice, the first inner excitation orifice having a smaller diameter than the first outer excitation orifice where the first inner and outer excitation orifice are in continuing alignment through a central portion of the optical block, wherein a center of the first inner and outer excitation orifice is in linear alignment with a center of the first reaction well excitation orifice;
a second inner excitation orifice and a second outer excitation orifice, the second inner excitation orifice having a smaller diameter than the second outer excitation orifice where the second inner and outer excitation orifice are in continuing alignment through the central portion of the optical block, wherein a center of the second inner and outer excitation orifice is in linear alignment with a center of the second reaction well excitation orifice;
an LED board having a first and a second LED, the LED board in removable attachment with the optical block where the first LED is received by the first outer excitation orifice and the second LED is received by the second outer excitation orifice;
a photodiode board having a first and a second photodiode, the photodiode board in removable attachment with the optical block where the first photodiode is received by the first outer emission orifice and the second photodiode is received by the second outer emission orifice;
a first excitation filter, the first excitation filter received by a ledge of the first outer excitation orifice, the ledge formed by the continuing alignment between the first inner and first outer excitation orifice;
a second excitation filter, the second excitation filter received by a ledge of the second outer excitation orifice, the ledge formed by the continuing alignment between the second inner and second outer excitation orifice;
a first emission filter, the first emission filter received by a ledge of the first outer emission orifice, the ledge formed by the continuing alignment between the first inner and first outer emission orifice;
a second emission filter, the second emission filter received by a ledge of the second outer emission orifice, the ledge formed by the continuing alignment between the second inner and second outer emission orifice; and
a heating element in heating communication with the heating block to provide heat transfer to the sample well and first and second reaction wells.

12. The device of claim, 11 further comprising
a first reaction vessel having a flat bottom configured for being received by the first reaction well, the first reaction vessel made from a material that is selected from the group consisting of glass and borosilicate glass;
a second reaction vessel having a flat bottom configured for being received by the second reaction well, the second reaction vessel made from a material that is selected from the group consisting of glass and borosilicate glass.

13. The device of claim 11, further comprising
a first reaction vessel having a flat bottom configured for being received by the first reaction well, the first reaction vessel made from a material that is thermally resistant plastic;
a second reaction vessel having a flat bottom configured for being received by the second reaction well, the second reaction vessel made from a material that is thermally resistant plastic.

14. The device of claim 11, wherein
the first outer excitation orifice has a diameter from 4 to 8 millimeters;
the first inner excitation orifice has a diameter from 2.5 to 5 millimeters;
the first outer emission orifice as a diameter from 4 to 8 millimeters;
the first inner excitation orifice has a diameter from 2.5 to 5 millimeters;
the second outer excitation orifice has a diameter from 4 to 8 millimeters;
the second inner excitation orifice has a diameter from 2.5 to 5 millimeters;
the second outer emission orifice as a diameter from 4 to 8 millimeters;
the second inner excitation orifice has a diameter from 2.5 to 5 millimeters.

15. The device of claim 14, wherein
the first reaction well excitation orifice has a diameter from 0.5 to 2 millimeters;
the first reaction well emission orifice has a diameter from 0.5 to 2 millimeters;
the second reaction well excitation orifice has a diameter from 0.5 to 2 millimeters;
the second reaction well emission orifice has a diameter from 0.5 to 2 millimeters.

16. The device of claim 11, wherein
the heating block material is anodized aluminum.

17. The device of claim 16, wherein
the optical block material is delrin.

18. The device of claim 16, wherein
the optical block material is selected from the group consisting of acetal copolymers and homopolymers.

19. The device of claim 1, wherein
the sample well has a diameter from 6 to 12 millimeters; and
the first reaction well has a diameter from 4 to 8 millimeters;
the second reaction well has a diameter from 4 to 8 millimeters.

20. The device of claim 1, wherein
the sample well is positioned at least 5 millimeters from the reaction well.

21. A limited well thermal cycling device for preparation of a biological sample for amplification and detection of an analyte, the limited well thermal cycling device comprising:
a heating block configured for preparation of the biological sample and amplification of the analyte, the heating block comprising
a sample well having a means for receiving a sample tube having a flat bottom, the sample well extending from a top of a heating block base;
a reaction well configured for amplifying an analyte of the prepared biological sample for detection, the reaction well extending from the top of the heating block base, wherein
the reaction well has an excitation orifice, an emission orifice, and a cooling orifice, where the excitation orifice and emission orifice are in 90 degree alignment; and
heating block alignment holes for removable attachment of an optical block to the heating block base, the heating block alignment holes on the top of the heating block base;
the optical block having a means for measuring the real time fluorescence of the analyte of the sample; and
a heating element in heating communication with the heating block to provide heat transfer to the sample well and reaction well.

22. A limited well thermal cycling device for preparation of a biological sample for amplification and detection of an analyte, the limited well thermal cycling device comprising:
a heating block configured for preparation of the biological sample and amplification of the analyte, the heating block comprising
a sample well having a tapered bottom configured for receiving and preparing the biological sample for amplification and detection, the sample well extending from a top of a heating block base;
a reaction well having a tapered bottom configured for receiving and amplifying an analyte of the prepared biological sample for detection, the reaction well extending from the top of the heating block base, wherein
the reaction well has an excitation orifice, an emission orifice, and a cooling orifice, where the excitation orifice and emission orifice are in 90 degree alignment; and
heating block alignment holes for removable attachment of an optical block to the heating block base, the heating block alignment holes on the top of the heating block base;
the optical block configured for detecting the analyte of the amplified and prepared biological sample, wherein the optical block is in removable attachment with the heating block, the optical block comprising
an inner excitation orifice and an outer excitation orifice, the inner excitation orifice having a smaller diameter than the outer excitation orifice where the inner and outer excitation orifice are in continuing alignment through a central portion of the optical block, wherein a center of the inner and outer excitation orifice is in linear alignment with a center of the reaction well excitation orifice;
an LED board having an LED, the LED board in removable attachment with the optical block where the LED is received by the outer excitation orifice;
a photodiode board having a photodiode, the photodiode board in removable attachment with the optical block where the photodiode is received by the outer emission orifice;
an excitation filter, the excitation filter received by a ledge of the outer excitation orifice, the ledge formed by the continuing alignment between the inner and outer excitation orifice;
an emission filter, the emission filter received by a ledge of the outer emission orifice, the ledge formed by the continuing alignment between the inner and outer emission orifice; and
a heating element in heating communication with the heating block to provide heat transfer to the sample well and reaction well.
